(19) United States
(12) Patent Application Publication
(10) Pub. No.: US 2006/0137467 A1
(43) Pub. Date: Jun. 29, 2006

(54) Floating-element shear-stress sensor using an optical Moire transduction technique

(76) Inventors: Stephen Brian Horowitz, Cilra, FL (US); Mark Sheplak, Gainesville, FL (US); Toshikazu Nishida, Gainesville, FL (US); Louis Nicholas Cattafesta III, Gainesville, FL (US); Ken K. Tedjojuwono, Newport News, VA (US)

Correspondence Address: AKERMAN SENTERFITT, P.O. BOX 3188, WEST PALM BEACH, FL, 33402-3188, US

(21) Appl. No.: 11/272,932

(22) Filed: Nov. 14, 2005

Related U.S. Application Data
(60) Provisional application No. 60/629,004, filed on Nov. 18, 2004.

(51) Int. Cl. G01N 3/32

(52) U.S. Cl. 73/815

(57) ABSTRACT

A Moiré interferometric-based shear-stress sensor includes a substrate support. The substrate includes a first optical grating disposed in or on the substrate, the first grating having a plurality of features defining a first spatial period. A floating element having a second optical grating is disposed in or on the floating element. The second grating has a plurality of features defining a second spatial period. The floating element is suspended over the first grating and flexibly connected to the substrate with compliant springs, wherein the respective gratings are in an optical path with one another. Upon irradiation, the sensor forms a Moiré fringe pattern which relates to a shear-stress induced translation of the floating element.

### CROSS-REFERENCE TO RELATED APPLICATIONS

The present application claims the benefit of U.S. provisional patent application No. 60/629,004 filed on Nov. 18, 2004, the entirety of which is incorporated herein by reference.

### STATEMENT REGARDING FEDERALLY SPONSORED RESEARCH OR DEVELOPMENT

The United States Government has rights in this invention pursuant to NASA-LaRC grant NAG-1-2133 and NASA-KSC grant NAG-10-316.

### FIELD OF THE INVENTION

The invention relates to sensors, and more particularly to Moiré interferometric-based shear-stress sensors.

### BACKGROUND

The measurement of mean and fluctuating wall shear-stress in laminar, transitional, and turbulent boundary layers and channel flows has applications both in industry and the scientific community. Time-resolved, fluctuating shear-stress data can also provide physical insight into complex flow phenomena, including turbulent viscous drag, transition to turbulence, flow separation, and shock-wave/boundary layer interactions. For example, the accurate measurement of skin friction is important to the aircraft industry.

Unfortunately, macro-scale measurement technology is insufficient to meet the demands of directly obtaining accurate mean and fluctuating wall shear stress data. More specifically, the accurate, direct measurement of fluctuating wall shear stress has not been realized via conventional measurement technology.

Micromachining technology provides the opportunity to synthesize transducers possessing superior performance compared to mainstream mechanical fabrication techniques. Specifically, the small physical size and corresponding reduced mass of micro-sensors offers the potential to vastly improve both the temporal and spatial measurement bandwidth.

Realizing the potential advantages of miniaturization scaling, the MEMS community has developed both thermal, floating element, and optical shear-stress sensors. Thermal sensors are generally robust and simpler to fabricate. However, they are based on a heat transfer analogy and absolute calibration for quantitative measurements is difficult. Optical MEMS (MOEMS)-based laser-Doppler anemometers that measure velocity gradients in the viscous sublayer are also known, but the ability to generate a sufficiently small measurement volume in a high-Reynolds number sublayer is challenging.

Floating-element structures provide a good opportunity to obtain direct quantitative, time-resolved measurements in a controlled wind tunnel environment. Several transduction techniques are known for measurement of the shear-stress induced deflection of floating elements, including capacitive, piezoresistive, and differential optical shutter techniques. However, no presently available shear-stress sensor is truly flush-mountable with no wire bonds that generate flow disturbances, and is also immune to non-shear stress inputs, such as electromagnetic interference (EMI) and pressure fluctuations.

### SUMMARY OF THE INVENTION

A Moiré interferometric-based shear-stress sensor includes a substrate support. The substrate includes a first optical grating disposed in or on the substrate, the first grating having a plurality of features defining a first spatial period. A floating element having a second optical grating is disposed in or on the floating element. The second grating has a plurality of features defining a second spatial period. The floating element is suspended over the first grating and flexibly connected to the substrate with compliant springs, wherein the respective gratings are in an optical path with one another. Upon irradiation, the sensor forms a Moiré fringe pattern which relates to a shear-stress induced translation of the floating element.

The substrate support can be substantially optically transparent (e.g. PYREX™). As used herein, “substantially optically transparent” refers to a maximum attenuation of 3 dB over at least a portion, and preferably over the full range, of optical wavelengths from 200 nm to 2000 nm. The optically transparent substrate provides backside optical access to the sensor, thus enabling flush mounting of the sensor front side.

In a preferred embodiment, the sensor is a MEMS sensor, such as formed using a silicon substrate. The floating element can comprise silicon, such as single crystal silicon. A ratio of fringe pitch (G) to a pitch of the second grating is preferably at least 10.

A sensor system for measuring shear-stress comprises a Moiré interferometric-based shear-stress sensor including a substrate support, the substrate including a first optical grating disposed in or on said substrate, the first grating having a plurality of features defining a first spatial period. A floating element having a second optical grating is disposed in or on the floating element. The second grating has a plurality of features defining a second spatial period, wherein the floating element is in an optical path with the first grating (e.g. suspended over) and flexibly connected to the substrate with compliant springs. Upon irradiation, the sensor forms a Moiré fringe pattern which relates to a shear-stress induced translation of said floating element. A light source irradiates the sensor with electromagnetic radiation, and a detector measures fringe patterns resulting from reflections of the radiation from the pair of gratings.

A method for measuring shear-stress comprising the steps of providing a Moiré interferometric-based shear-stress sensor including a pair of gratings in an optical path and a floating element, irradiating the sensor with electromagnetic radiation, measuring a Moiré fringe pattern resulting from reflections of radiation from the pair of gratings, and using the Moiré fringe pattern for determination of displacement of the floating element to determine shear-stress. In a preferred embodiment, one of the pair of gratings comprises a grating disposed in or on the floating element.

The sensor is preferably a MEMS sensor, the MEMS sensor including a semiconducting or dielectric substrate. In one embodiment, the substrate is substantially optically transparent to the electromagnetic radiation. In this embodiment, the step of irradiating the sensor can comprise applying incident radiation to the substrate. In one embodiment, the substrate is single crystal silicon and the floating element is formed from the single crystal silicon. In another embodiment, the substrate comprises silicon-on-insulator (SOI). In the SOI embodiment, the floating element is formed in or on a Si-overlayer of the SOI substrate.

### BRIEF DESCRIPTION OF THE DRAWINGS

There is shown in the drawings embodiments which are presently preferred, it being understood, however, that the invention can be embodied in other forms without departing from the spirit or essential attributes thereof.

FIG. 1(a) shows a schematic plan view and FIG. 1(b) a cross-section of a conventional floating-element sensor (Prior Art).

FIG. 2(a) shows a top view and FIG. 2(b) a cross sectional schematic of an optical shear-stress sensor, according to an embodiment of the invention.

FIG. 3 shows the Moiré fringe pattern generated from an optical shear-stress sensor according to an embodiment having two gratings where the fixed grating pitch g₁=9.9 μm, the moveable grating pitch g₂=10 μm, and G (the Moiré fringe pitch) G, is =990 μm.

FIG. 4(A)-(C) shows schematics of intermediate layer stacks based on an exemplary fabrication sequence, to form the completed optical shear-stress sensor shown in FIG. 4(D), according to an embodiment the invention. FIG. 4(A) shows 2 μm etch recesses formed in a Si-overlayer of a silicon-on-insulator (SOI) wafer, having gratings (0.25 μm—Al) from a deposition and patterning process. FIG. 4(B) shows a pattern of handle gratings from deposition and patterning on a Pyrex wafer (0.25 μm—Al). FIG. 4(C) shows the stack resulting after alignment, then anodic bonding of the Pyrex wafer (FIG. 4(B)) to the patterned SOI wafer (FIG. 4(A)). FIG. 4(D) shows a completed optical shear stress sensor after thinning the back the bulk of the SOI wafer using a wet silicon tech (KOH), with the etch stopping on the buried oxide (BOX), then DRIE processing is used to release the floating element and tethers.

FIG. 5 is a schematic diagram of static calibration experimental setup illustrating backside imaging optics for a 2-D laminar flow cell.

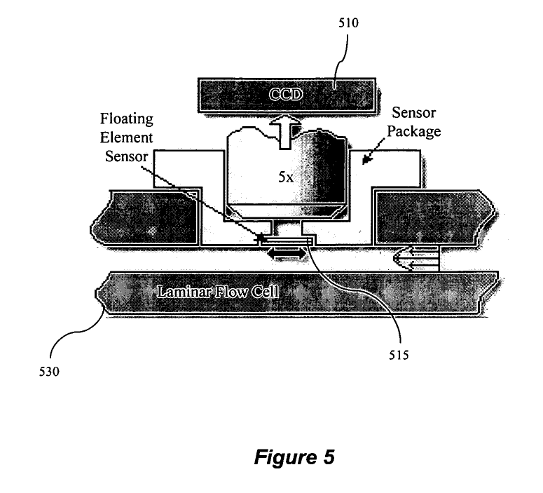

FIG. 6 is a schematic diagram of an experimental setup for static calibration.

FIG. 7 is a schematic diagram of experimental setup for dynamic calibration.

FIG. 8 shows a Moiré fringe pattern for shear stress of 0 Pa as seen by 1024 pixel linescan camera. Successive frames from the camera are stacked vertically.

FIG. 9 shows measured relative pixel intensity for 0 Pa and 1.3 Pa of shear stress.

FIG. 10 shows the static response of a sensor according to the invention in terms of Moiré fringe pixel displacement and corresponding mechanical displacement as a function of mean shear stress. The static sensitivities are 13.0 pixels/Pa and 0.26 μm/Pa.

FIG. 11 shows the Moiré fringe pattern for a sinusoidal shear stress of amplitude 0.061 Pa and frequency of 1 kHz. Note: image has been modified to emphasize oscillations.

FIG. 12: shows a time-domain waveform of Moiré shift in terms of CCD camera pixels for a sinusoidal shear stress of amplitude 0.061 Pa and frequency of 1 kHz. The dots are the actual samples taken and the line is a curve fit to the data.

FIG. 13 shows the magnitude of normalized frequency response function.

FIG. 14 shows a noise floor spectrum of sensor with a 1 Hz bandwidth. For a 1 Hz bin centered at 1 kHz, the noise floor is 1.6 nm/(Hz)^{1/2} which corresponds to a minimum detectable shear stress of 6.2 mPa/(Hz)^{1/2}.

### DETAILED DESCRIPTION OF THE INVENTION

A Moiré interferometric-based shear-stress sensor includes a substrate support including a first optical grating disposed in or on the substrate. The first grating has a plurality of features defining a first spatial period. A floating element having a second optical grating is disposed in or on the floating element. The gratings can be defined within the substrate and/or floating element using a variety of processes, such as a damascene process. The second grating has a plurality of features defining a second spatial period. The floating element is in an optical path with, such as being suspended over with the first grating and flexibly connected to the substrate with compliant springs, wherein the first and second gratings overlay one another. Reflection of light irradiated on the gratings forms a Moiré fringe pattern which relates to a shear-stress induced translation of the floating element. Similarly, transmission of light through the gratings also forms a Moiré fringe pattern that is related to the shear-stress induced translation of the floating element.

The shear-stress sensor is preferably a MEMS sensor which permits micromachined features to be precisely formed at a low cost and the ability to include optical components, such as a light source such as a laser diode and mirrors, and electronic components, including detectors (e.g. photodiodes), signal processors, A/D converters, microprocessors and filters on the sensor chip, as well as other sensors or multiple shear-stress sensors on the chip. The system can be all on one chip, although using a few separate chips in a hybrid package would lead to a small enough device to be useful.

The invention thus addresses the limitations of existing MEMS shear stress sensor technology by providing a sensor which permits the direct measurement of skin friction based on geometric Moiré interferometry. A Moiré fringe pattern occurs when two gratings of almost identical spatial period are superimposed, and can be regarded as a type of spatial beating phenomenom. The Moiré pattern is produced by patterning one grating on a fixed base substrate structure and a second grating on a laterally movable floating element disposed directly above the base grating. The floating element is preferably physically connected to the substrate via compliant tethers. When the sensor device is illuminated, light is reflected by the superposed top and bottom gratings, creating a floating element translation-dependent Moiré fringe pattern.

Under an applied shear stress, the floating element deflects laterally due to the compliant tethers, resulting in a lateral displacement of the floating element grating with respect to the fixed grating disposed on the substrate. This leads to a correspondingly larger displacement of the Moiré pattern.

The floating element can also displace vertically, though this effect can be reduced through appropriate design of the tethers. A vertical displacement does not result in any change in the Moiré pattern to first degree (i.e. same Moiré period and phase), however if the vertical displacement moves the second grating away from the focal plane, it may lead to some blurring of the image of that grating, which is not necessarily detrimental to the measurement.

The Moiré fringe shift amplifies small displacements by the ratio of the fixed fringe pitch to the movable grating pitch, and can be quantified as described below. With appropriate design, this ratio can be made sufficiently large enough to amplify the floating element displacement by several orders of magnitude, thereby facilitating highly accurate and sensitive measurement of the applied shear stress.

The Moiré fringe pattern is preferably detected using a digital imaging system, such as a CCD camera, phototransistor, or photodiode array. The phase of the Moiré pattern can be determined from the recorded image. Sensors according to the invention are immune to EMI and intensity fluctuations of the light source, as only the phase of the resulting Moiré pattern is generally of importance.

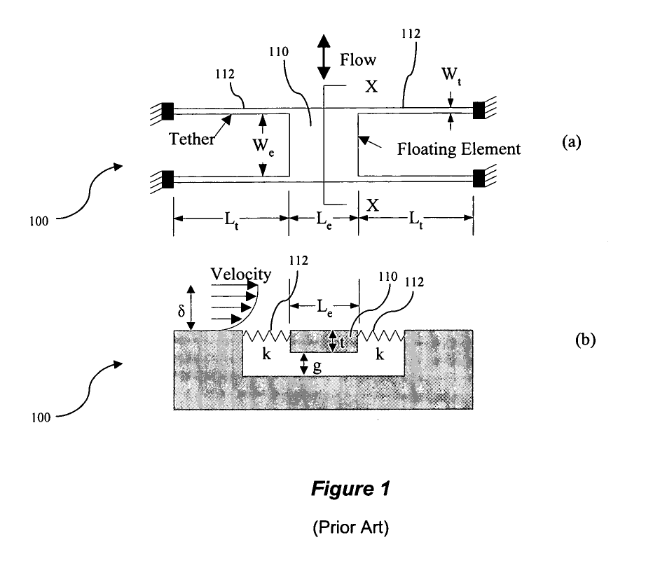

A cross-sectional schematic of a conventional MEMS floating element sensor 100 is shown in FIGS. 1(a) and (b). The sensor 100 shown is generally capacitive or piezoresistive sensing-based. The floating element 110 possesses a length, Le, width W, and thickness t. The floating element 110 is suspended over a recessed gap g by silicon tethers 112 that also serve as restoring springs. The displacement 6 of the floating element as a function of wall shear stress, τ_{w}, is determined via Euler-Bernoulli beam theory to be:

$$δ = {τ}_{w} \frac{{L}_{e} {W}_{e}}{4 E t} {( \frac{{L}_{t}}{{W}_{t}} )}^{3} \{ 1 + 2 \frac{{L}_{t} {W}_{t}}{{L}_{e} {W}_{e}} \} \qquad ( 1 )$$

where Lₜ is the length of the length 112, Wt is the tether width, and E is the elastic modulus of the tether 112. Euler-Bernoulli beam theory assumes small deflections such that the strain at the neutral axis of the beam can be neglected. For sufficiently large shear stresses applied to a device, this theory will fail. The limits of this approximation can be approximated via a large deflection energy-based solution:

$$δ [ 1 + ( \frac{3}{4} ) {( \frac{δ}{{W}_{t}} )}^{2} ] = {\frac{{τ}_{w} {W}_{e} {L}_{e}}{4 E t} [ \frac{{L}_{t}}{{W}_{t}} ]}^{3} [ 1 + 2 \frac{{W}_{t} {L}_{t}}{{W}_{e} {L}_{e}} ] \qquad ( 2 )$$

From Eq. (2), it is clear that the maximum deflection of the floating element must be a fraction of the tether width Wt for the small deflection solution given in Eq. (1) to be valid. The floating element 110 possesses an effective mass, M, and the tethers 112 possess an effective spring constant, k. The mechanical sensitivity of the sensor with respect to the integrated shear stress force copy in, is directly proportional to the compliance of the tethers, 1/k:

$$\frac{1}{k} = \frac{δ}{{F}_{τ}} = \frac{1}{4 E t} {( \frac{{L}_{t}}{{W}_{t}} )}^{3} \{ 1 + 2 \frac{{L}_{t} {W}_{t}}{{L}_{e} {W}_{e}} \} \qquad ( 3 )$$

The compliance of sensor 100 is limited either by failure at the maximum applied shear stress or from the onset of geometric nonlinearities in the force-displacement relationship shown in Eq. (2). The requirement of high spatial resolution requires the measurement of very small forces. For example, a sensor possessing a 100 μm² floating element structure would need to measure a 10 pN force to resolve a shear stress level of 1 mPa, thus requiring a highly compliant structure. If LₑWₑ>>LₜWₜ then the effective mass is approximated by M˜ρLₑWₑt, where ρ is the mass-averaged density of the element material. Assuming a perfectly-damped or under-damped system, the bandwidth is proportional to the first resonance of the device, (k/M)^{1/2}. Therefore, the shear-stress sensitivity-bandwidth product for sensor 100 is proportional to:

$$\frac{1}{\sqrt{k M}} ∝ \sqrt{\frac{1}{4 E ρ {L}_{e} {W}_{e} {t}^{2}} {( \frac{{L}_{t}}{{W}_{t}} )}^{3}} \qquad ( 4 )$$

The sensitivity-bandwidth product is a useful figure of merit to investigate the scaling of mechanical sensors analogous to the gain bandwidth product of an operational amplifier. This figure of merit illustrates that MEMS technology enables the development of low mass, compliant mechanical sensors possessing superior sensitivity-bandwidth products relative to conventional sensors. As is the case in all transducers, the minimum detectable signal will be determined by the electronic and/or thermal mechanical noise floor of the measurement system. The favorable miniaturization scaling of the mechanics of the structure is somewhat mitigated by the requirement to measure very small displacements on the order of Angstroms (Å).

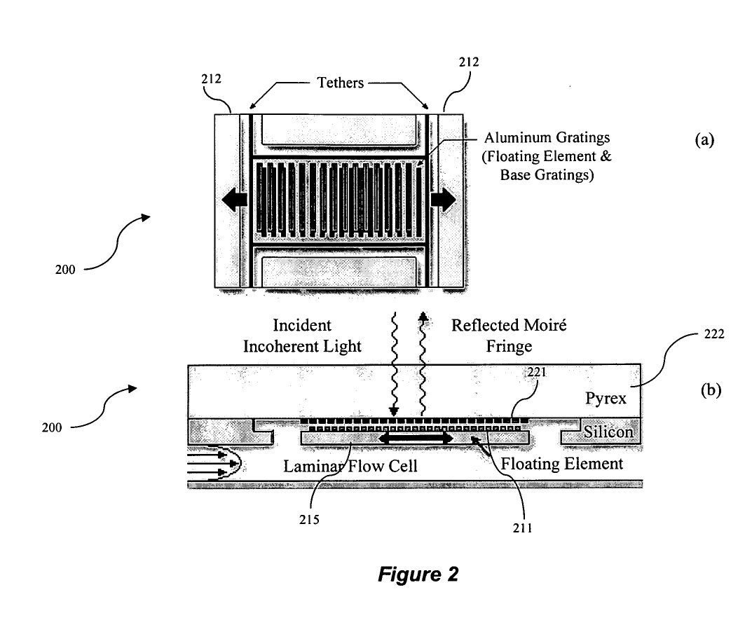

FIGS. 2(a) and 2(b) show a schematic top and cross sectional view of a floating element shear-stress sensor 200 based on optical Moiré transduction, according to an embodiment of the invention. In contrast to conventional sensor 100, sensors according to the invention utilize a displacement transducer that comprises an optical grating 211 on the backside of a floating element 215 and an optical grating 221 on the top surface of a support substrate 222 (e.g. wafer). Floating element 215 is held by tethers 212. The respective gratings 211 and 221 superimpose to form a Moiré fringe when irradiated by incident light which amplifies the translation of the floating element 215. An exemplary sensor 200 according to the invention consists of a 1280 μm×400 μm single crystal silicon floating element 215 of 10 μm thickness, suspended 2.0 μm above the surface of a 500 μm thick PYREX® (a borosilicate glass with a low coefficient of expansion) substrate 222 wafer by four 545 μm×6 μm tethers 212 of 10 μm thickness. An advantage of a single crystal floating element 215 is that the process used to create such material leads to a low residual stress within the material, which is important in terms of achieving a good sensitivity and frequency response from the sensor 200.

For example, the Moiré pattern can be realized by patterning aluminum lines with a different pitch on the bottom of the floating element 215 as compared to the lines on the substrate 222. When the device is illuminated, through the optically transparent PYREX substrate 222, light is reflected by the superposed top and bottom gratings, creating a translation-dependent Moiré fringe pattern. The Moiré pattern can be alternatively be created by illuminating the device through the floating element 215 via the transmission of light through the superposed top and bottom gratings 211 and 221. From the Moiré fringe pattern, the applied shear-stress can be obtained as described below.

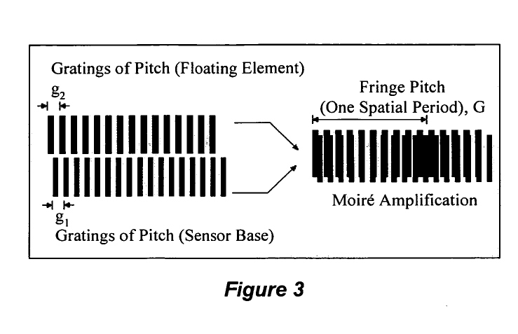

FIG. 3 shows the Moiré fringe pattern generated from an optical shear-stress sensor according to an embodiment having two gratings where the fixed grating 221 pitch g₁=9.9 μm, the moveable grating 211 pitch g₂=10 μm, and G (the Moiré fringe pitch) G, is =990 μm. A Moiré fringe pattern occurs when two gratings of almost identical spatial period are superimposed as shown. The Moiré fringe shift G, is related to the individual grating pitches, g₁ and g₂, by:
G=g₁g₂/(g₂−g₁) (5)

The Moiré fringe shift amplifies small displacements by the ratio of the fringe pitch, G, to the movable grating pitch, g₂, and is invariant to intensity modulations of the irradiation source provided the temporal intensity modulations are spatially uniform across the sensor. In other words, if it suddenly gets twice as bright in the center of the sensor, it should also get twice as bright near the edges of the sensor. This is a reasonable assumption for most sources of light. The displacement Δ of the Moiré fringe is given by:

$$Δ = δ ( \frac{G}{{g}_{1}} ) \qquad ( 6 )$$

where δ is the physical displacement of the floating element displacement. The Moiré fringe displacement is therefore amplified over the grating displacement by a factor of G/g₁. For the exemplary sensors described in this application, g₁=9.9 μm, g₂=10 μm, and G=990 μm.

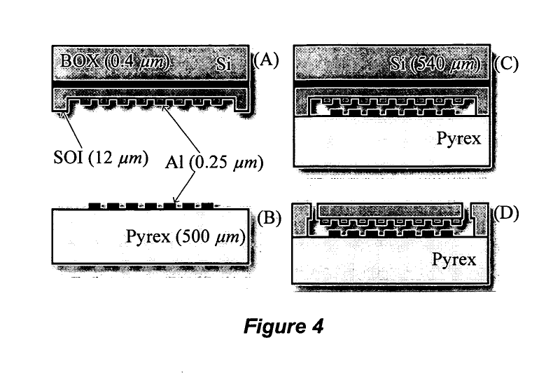

FIG. 4(A)-(C) shows schematics of intermediate layer stacks based on an exemplary fabrication sequence, to form the completed optical shear-stress sensor shown in FIG. 4(D), according to an embodiment the invention. FIG. 4(A) shows 2 μm etch recesses formed in a Si-overlayer of a silicon-on-insulator (SOI) wafer, having gratings (0.25 μm—Al) from a deposition and patterning process. FIG. 4(B) shows a pattern of handle gratings from deposition and patterning on a Pyrex wafer (0.25 μm—Al). FIG. 4(C) shows the stack resulting after alignment, then anodic bonding of the Pyrex wafer (FIG. 4(B)) to the patterned SOI wafer (FIG. 4(A)). FIG. 4(D) shows a completed optical shear stress sensor after thinning the back the bulk of the SOI wafer using a wet silicon tech (KOH), with the etch stopping on the buried oxide (BOX), then DRIE can be used to release the floating element and tethers.

Thus, new aspects of sensors according to the invention include the use of Moiré fringe patterns for determination of floating element displacement which permits determination of shear-stress, use of periodic grating structures on a floating element sensor, and use of an optically transparent base (e.g. PYREX™) that provides backside optical access to the sensor, thus enabling flush mounting of the sensor front side.

### ALTERNATE EMBODIMENTS

In addition, related imaging systems based on the invention can reduce package size and improve portability. One such system employs a borescope that allows for remote mounting of a CCD (or other) camera and permits the package size to be reduced to the order of the boroscope diameter of around a centimeter. A borescope, which is a device for internal inspection of parts such as rifle barrels, uses a set of relay lenses to optically transmit an image from the sensing end to an eyepiece and/or CCD camera. By utilizing a borescope based package, the Moiré pattern can be transmitted to the remotely mounted CCD camera. Another related system replaces the CCD camera with a small linear array of photosensitive elements which may be integrated or hybrid packaged with the sensor chip. The idea behind this concept is that the total number of elements in the array can be significantly reduced from the 1024 element CCD camera array without significantly reducing the ability to measure the phase shift of the Moiré pattern.

The sensor geometry and Moiré fringe design can be further optimized. Significant improvements in the resonant frequency without sacrificing sensitivity can be achieved through a mechanically optimized design, leading to an improved gain bandwidth product. Mechanical optimization can be achieved through adjustment of the sensor geometry. Second, the Moiré amplification can be improved by decreasing the difference in grating pitches. This leads to an increased sensitivity without a corresponding reduction in bandwidth.

Although embodied as a shear-stress sensor, the invention is in no way limited to shear-stress sensors. For example, devices according to the invention can be used to measure other physical quantities such as acceleration, velocity, position, and temperature, upon minor modification of the sensor. For acceleration sensing, for instance, a proof mass could be added to the floating element to increase the sensitivity to inertial forces.

### EXAMPLES

The present invention is further illustrated by the following specific simulation Examples, which should not be construed as limiting the scope or content of the invention in any way.

Prior to testing, a shear stress sensor according to the invention was packaged by inserting the sensor die 515 flush-mounted in a Lucite plug with front-side imaging optics and a Thomson-CSF TH78CE13 linescan CCD camera 510. The CCD camera 510 contained an array of 1×1024 pixels, each 10 μm in width. The packaged sensor device was then mounted into a 100 mm×1 mm flow cell 530 that provides a variable mean shear stress via a laminar, incompressible, fully developed, 2-D pressure driven flow in a slot.

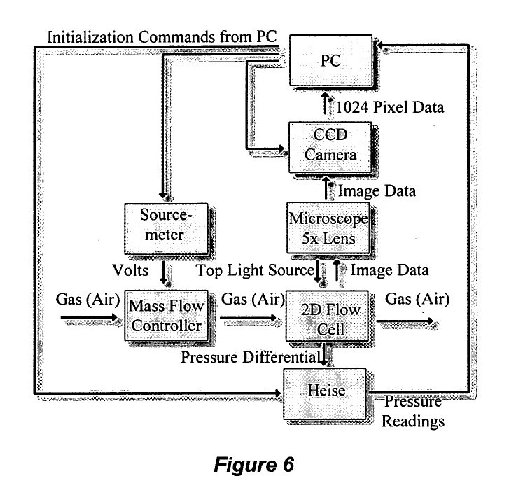

A block diagram of the static calibration procedure is shown in FIG. 6. A mass flow controller was used to provide a steady flow of air through a laminar flow cell, and was controlled by a PC via a Keithley 2000 Sourcemeter. The differential pressure between two locations in the fully-developed region of the laminar flow cell was measured using a Heise pressure sensor, which was then used to compute the applied shear stress to the sensor. This differential pressure measurement is averaged 100 times and used to compute the applied shear stress using:

$${τ}_{w} = - \frac{h}{2} \frac{Δ p}{L} \qquad ( 7 )$$

where Δp is the differential pressure, h is the height of the channel, and L is the distance separating the pressure ports.

The Moiré fringe pattern was captured using the CCD camera coupled to a 5× optical lens. The capture process was repeated 600 times to obtain an average fringe pattern for a no-flow or zero shear stress case. The resulting intensity pattern was normalized by a calibration image to eliminate pixel gain variations and non-uniform illumination effects. A Fast-Fourier Transform (FFT) was performed on the averaged fringe pattern. The phase of the Moiré pattern was then extracted from the FFT at the frequency corresponding to the Moiré pitch. This phase was then used as the zero reference point for determining the phase shift at an applied level of shear stress. The procedure was then repeated for a given applied shear stress and the corresponding intensity pattern to obtain the phase shift and, hence, the pixel shift. Using knowledge of the Moiré pattern and optical magnification, the corresponding mechanical displacement of the floating element was then computed to give a direct measurement of the wall shear stress.

Dynamic Calibration Setup

Dynamic calibration was performed using acoustic excitation of shear-stress in a plane-wave tube. This technique utilizes acoustic plane waves in a duct to generate known oscillating wall shear stresses. The basic principle of this technique relies on the fact that the particle velocity of the acoustic waves is zero at the wall due to the no-slip boundary condition. This leads to the generation of a frequency-dependent boundary layer thickness and a corresponding wall shear stress. Specifically, the linearized compressible momentum equation in the axial direction reduces to the classic problem of a duct flow driven by an oscillatory pressure gradient. Therefore, at a given location, the relationship between the fluctuating shear stress and acoustic pressure is known theoretically.

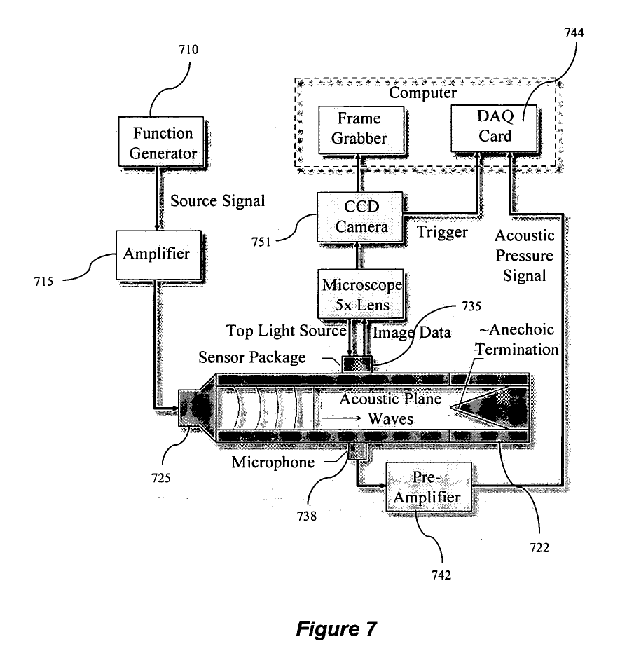

A conceptual schematic of the dynamical calibration setup used is shown in FIG. 7. A function generator 710 was used to generate a known sinusoidal input that was then amplified by amplifier 715 and routed to a JBL 2426H speaker 725 mounted to the end of the plane-wave tube 722. The shear stress sensor 735 was flush mounted to the wall of the plane wave tube 722 directly across from a CCD Briel & Kjaer 4138 ⅛″ microphone 738. The CCD camera 751 and frame grabber from the static calibration setup were used to record an image of the shear stress sensor 735.

In the dynamic calibration, however, the camera 751 was programmed to record 16,384 lines at a line rate of 11.42 kHz. The microphone signal was routed through a SRS-560 preamplifier 742 to provide AC coupling and recorded by a DAQ card 744. The DAQ card is programmed to sample at the same linescan rate as the camera 751 and is triggered by a synchronization pulse from the camera 751 to provide simultaneous sampling of the microphone 738 and shear stress signals.

Static Calibration Results

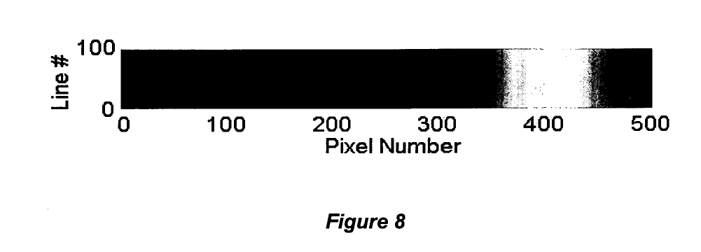

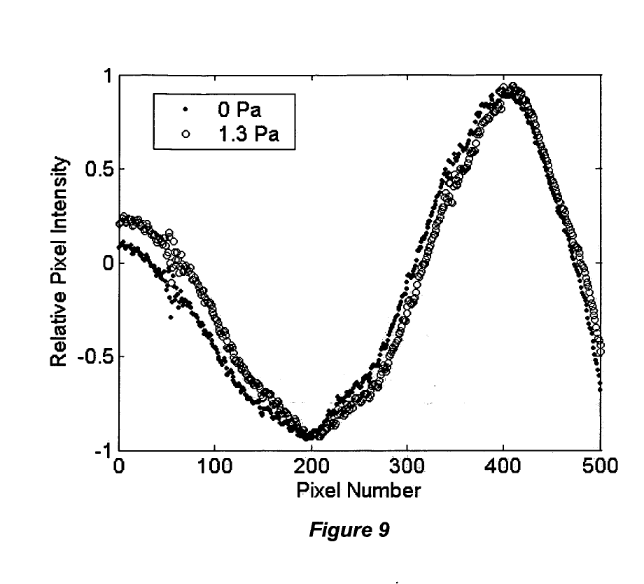

The recorded Moiré intensity pattern for a shear stress of 0 Pa (static) is shown in grayscale in FIG. 8, and the fringe pattern for shear stresses of 0 Pa and 1.3 Pa are shown vs. pixel number in FIG. 9. The peak in relative intensity corresponds to brightest in the grayscale image. The Moiré pattern was found to have a spatial period of 1002 μm, before the 5× optical amplification, compared to the physical grating period of 10 μm. The Moiré amplification for the sensor was then found to be 101.2 compared to the designed value of G/g₁=100.

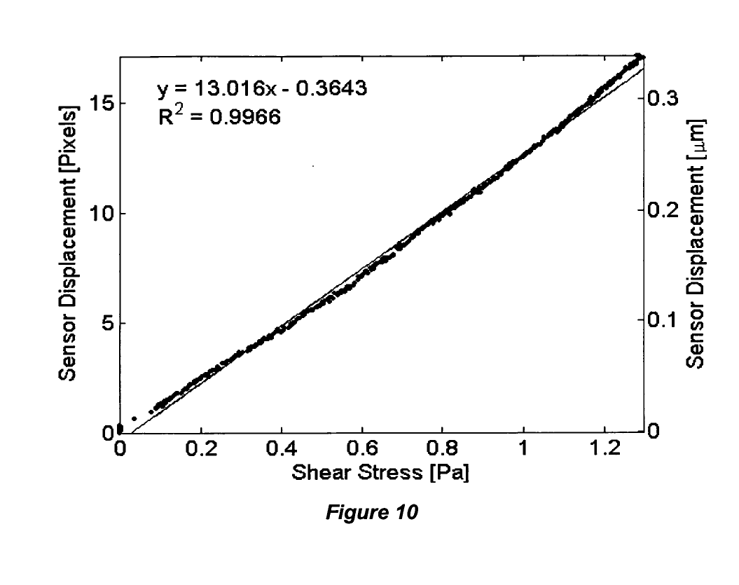

Following the procedure outlined above, the pixel shift of the Moiré fringe pattern was then determined for a range of applied shear-stress. The results are shown in FIG. 10, along with the corresponding mechanical displacement. The mechanical sensitivity, as found from the slope of this curve, is 0.26 μm/Pa, while the Moiré fringe, after the 5× optical amplification, was found to move by 130.02 μm/Pa. The recessed gap under the floating element gives rise to pressure-gradient induced errors. The magnitude of the effective shear-stress, τ_{eff}, acting in the presence of a pressure gradient has been shown to be:

$${τ}_{eff} = ( 1 + \frac{g}{h} + \frac{2 t}{h} ) {τ}_{w} \qquad ( 8 )$$

where h is the channel height of the wind tunnel used for calibration, g is the recessed gap, and τ_{w} is the actual wall shear stress. The second and third terms in the bracket are the error terms associated with flow under the floating element and the pressure gradient acting on the lip of the element, respectively. For the device and experimental apparatus used, this component of the calibration error was about 2%.
Dynamic Calibration Results

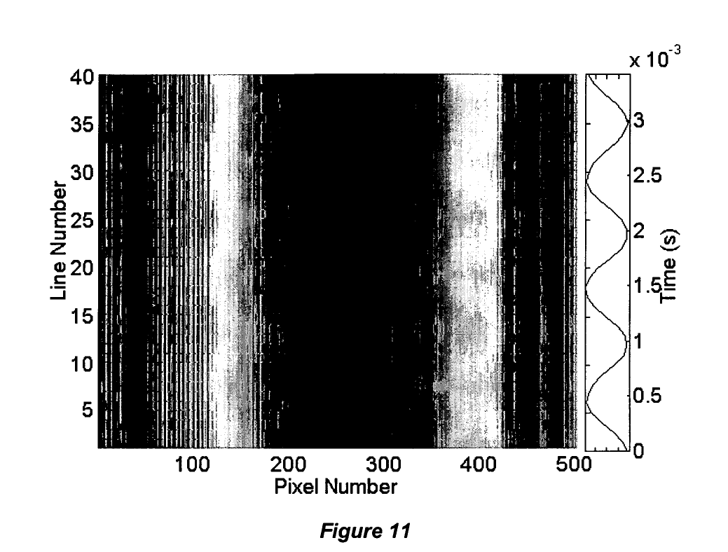

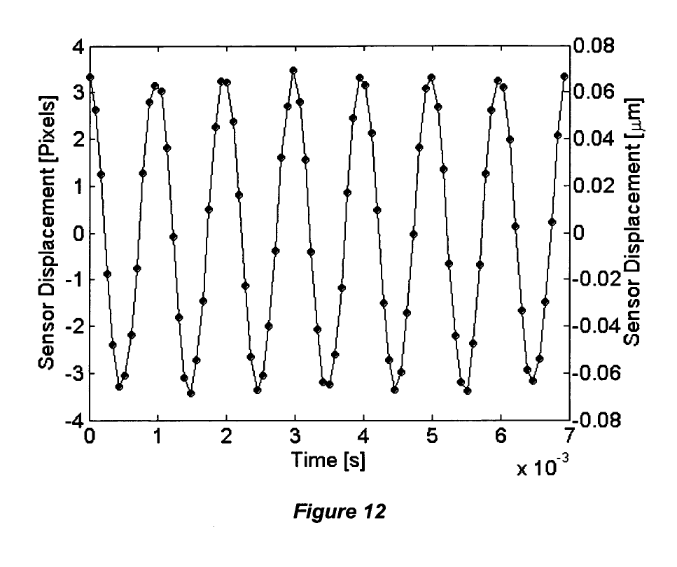

FIG. 11 shows a “stacked” Moiré fringe pattern image of 40 successive line scans resulting from a sinusoidal shear stress of amplitude 0.061 Pa and frequency of 1 kHz. Successive lines from the camera are stacked vertically illustrating the oscillatory fringe pattern. The sinusoidal time trace on the right represents the input oscillatory shear stress. The data reduction procedure outlined above is used to compute the instantaneous sensor displacement for each line. Time series data illustrating the dynamic response of the sensor in terms of Moiré fringe pixel displacement and corresponding mechanical displacement for a 1 kHz sinusoidal input of 0.061 Pa is shown in FIG. 12. The amplitude of the sensor displacement is approximately 3 pixels or 0.06 μm.

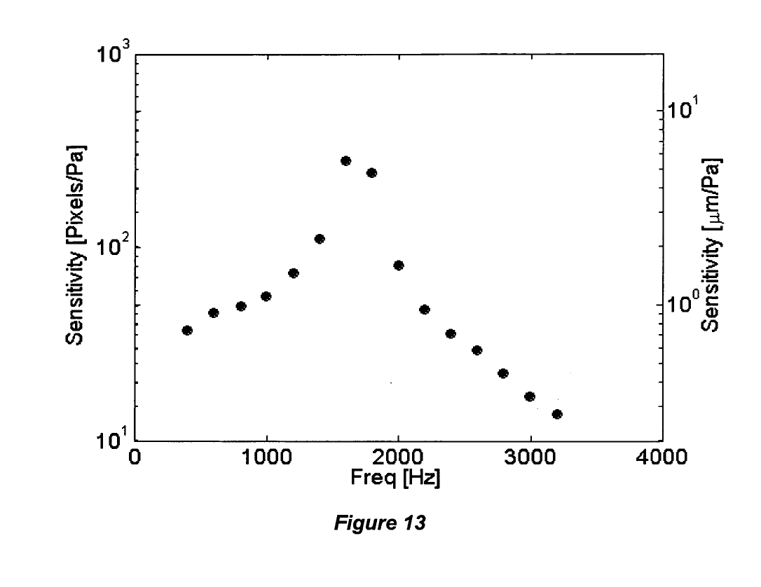

A preliminary estimate of the frequency response function gain factor is shown in FIG. 13 which indicates a first lateral mode resonant frequency at 1.7 kHz. The corresponding phase has not been accurately estimated due to synchronization issues between the linescan CCD and the microphone channel's analog-to-digital converter. This issue arose despite the trigger signal from the CCD camera that is used to trigger the start of microphone sampling. It is believed that round-off error in the sampling rate of the DAQ card leads to a gradual loss of synchronization over time.

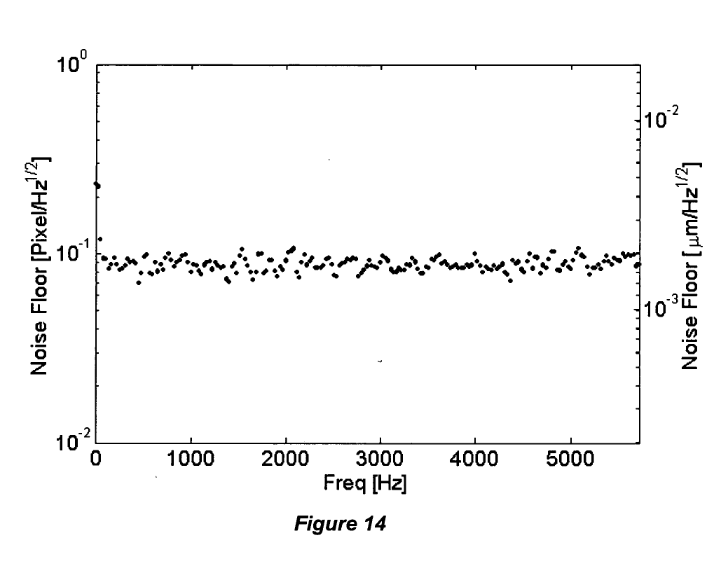

The dynamic range of the sensor is generally ultimately limited by the device noise floor. The noise floor spectrum was obtained by recording microphone and CCD data with no acoustic input signal. An estimate of the noise floor magnitude in is shown in FIG. 14. For a 1 Hz bin centered at 1 kHz, the noise floor is 1.6 nm/(Hz)^{1/2} or 0.08 pixels/(Hz)^{1/2}, which corresponds to a minimum detectable shear stress of 6.2 mPa/(Hz)^{1/2}.

This invention can be embodied in other forms without departing from the spirit or essential attributes thereof and, accordingly, reference should be had to the following claims rather than the foregoing specification as indicating the scope of the invention.

We claim:

1. A Moiré interferometric-based shear-stress sensor, comprising:
a substrate support, said substrate including a first optical grating disposed in or on said substrate, said first grating having a plurality of features defining a first spatial period, and
a floating element having a second optical grating disposed in or on said floating element, said second grating having a plurality of features defining a second spatial period, said floating element suspended over said first grating and flexibly connected to said substrate with compliant springs, wherein said first and second gratings are in an optical path with one another, said sensor upon irradiation forming a Moiré fringe pattern which relates to a shear-stress induced translation of said floating element.

2. The sensor of claim 1, wherein said substrate support is substantially optically transparent.

3. The sensor of claim 1, wherein said sensor is a MEMS sensor.

4. The sensor of claim 3, wherein said floating element comprises silicon.

5. The sensor of claim 4, wherein said silicon is single crystal silicon.

6. The sensor of claim 1, wherein a ratio of fringe pitch (G) to a pitch of said second grating is at least 10.

7. A sensor system for measuring shear-stress, comprising:
A Moiré interferometric-based shear-stress sensor including a substrate support, said substrate including a first optical grating disposed in or on said substrate, said first grating having a plurality of features defining a first spatial period, and a floating element having a second optical grating disposed in or on said floating element, said second grating having a plurality of features defining a second spatial period, said floating element suspended over said first grating and flexibly connected to said substrate with compliant springs, wherein said first and second gratings are in an optical path with one another, said sensor upon irradiation forming a Moiré fringe pattern which relates to a shear-stress induced translation of said floating element;
a light source for irradiating said sensor with electromagnetic radiation, and
a detector for measuring fringe patterns resulting from reflections of said radiation from said first and second grating.

8. A method for measuring shear-stress, comprising the steps of:
providing a Moiré interferometric-based shear-stress sensor including a pair of gratings in an optical path and a floating element;
irradiating said sensor with electromagnetic radiation;
measuring a Moiré fringe pattern resulting from reflections of said radiation from said pair of gratings, and
using said Moiré fringe pattern for determination of displacement of said floating element to determine shear-stress.

9. The method of claim 8, wherein one of said pair of gratings comprises a grating disposed in or on said floating element.

10. The method of claim 8, wherein said sensor is a MEMS sensor, said MEMS sensor including a semiconducting or dielectric substrate.

11. The method of claim 10, wherein said substrate is substantially optically transparent to said electromagnetic radiation.

12. The method of claim 11, wherein said step of irradiating said sensor comprises applying incident radiation to said substrate.

13. The method of claim 10, wherein said substrate is single crystal silicon and said floating element is formed from said single crystal silicon.

14. The method of claim 10, wherein said substrate comprises silicon-on-insulator (SOI).

15. The method of claim 14, wherein said floating element formed in or on a Si-overlayer of said SOI substrate.
